(19) United States
(12) Patent Application Publication
(10) Pub. No.: US 2019/0370683 A1
(43) Pub. Date: Dec. 5, 2019

(54) Method, Apparatus and Computer Program for Operating a Machine Learning System

(71) Applicant: Robert Bosch GmbH, Stuttgart (DE)

(72) Inventor: Jan Hendrik Metzen, Boeblingen (DE)

(21) Appl. No.: 16/407,537

(22) Filed: May 9, 2019

(30) Foreign Application Priority Data
Jun. 4, 2018 (DE) 10 2018 208 763.6

(51) Int. Cl. G06N 20/00

(52) U.S. Cl. CPC G06N 20/00; G06N 3/08

(57) ABSTRACT

The disclosure relates to a method for operating a machine learning system with the following steps. First training of the machine learning system depending on training input values provided and respectively associated training output values. Determine a universal adversarial perturbation depending on a specifiable plurality of the training input values. Perturbing each of the specifiable plurality of the training input values by means of the universal adversarial perturbation. Second training of the machine learning system, at least as a function of the perturbed plurality of training input values and a multiplicity of the training input values. The disclosure also relates to a computer program and an apparatus for executing the method and a machine-readable storage element on which the computer program is stored.

This application claims priority under 35 U.S.C. § 119 to application no. DE 10 2018 208 763.6, filed on Jun. 4, 2018 in Germany, the disclosure of which is incorporated herein by reference in its entirety.

### TECHNICAL FIELD

The disclosure relates to a method for operating a machine learning system. The disclosure also relates to an apparatus and a computer program, each of which is configured to execute the method.

### BACKGROUND

The unpublished patent application DE 10 2018 200 724.1 and the publication by the author Metzen, Jan Hendrik, et al., “Universal adversarial perturbation against semantic image segmentation” stat, 2017, 1050. Vol., p. 19 disclose a method for generating a universal data signal perturbation to generate a manipulated data signal for deceiving a machine learning system.

### SUMMARY

In a first aspect a method for operating a machine learning system according to the disclosure, the method comprises the following steps, among others:

The method begins with an initial training of the machine learning system depending on the training input values provided and respectively associated training output values. A universal adversarial perturbation is then determined depending on a specifiable plurality of the training inputs. Subsequently, the universal adversarial perturbation is applied to each of the specifiable plurality of the training inputs. Thereafter, a second training of the machine learning system is carried out, at least as a function of the perturbed plurality of the training inputs and a multiplicity of the training inputs.

If the training input values that were used to determine the universal adversarial perturbation are each perturbed with the universal adversarial perturbation, this can cause the subjected training inputs to deceive the machine learning system. In other words, the trained machine learning system, which was trained in the initial training step, does not determine the training output values that are associated with the respective perturbed training input values. For example, a deviation, in particular a small deviation, of the determined output values of the deceived machine learning system from the training output values can give rise to an incorrect classification or segmentation of the inputs of the machine learning system. In the perturbation, at least one section of the input value is additively perturbed with the universal adversarial perturbation.

The universal adversarial perturbation may also be determined depending on a cost function of the machine learning system. The cost function characterizes, as a function of the parametrization of the machine learning system, a difference between the training output values and the determined output values of the machine learning system depending on the training input values.

The advantage of this method is that the universal adversarial perturbation is determined from the training data and thus a more robust machine learning system can be generated already at the training stage. In addition, the specifiable number of training inputs used to determine the universal adversarial perturbation saves computing effort while maintaining the advantage of universal adversarial perturbations. A further advantage is that at the same time the machine learning system is more robust against manipulated input values, without reducing the prediction quality for unmanipulated input data. It has also been recognized that the robustness against non-universal adversarial perturbations can also be increased by means of this method. The advantage of the mixture of manipulated training data and non-manipulated training data is that it is possible to variably set whether the machine learning system should have a high prediction quality or a particularly pronounced robustness against adversarial perturbation of the input data.

It is also proposed that at least the steps, in particular of the first training, the determination of the universal adversarial perturbation followed by the perturbation of the specifiable plurality of the training input values and the second training phase, can be repeated at least once.

The advantage is that by the re-determination of the universal adversarial perturbation, the machine learning system does not learn this by rote during the second training phase of the machine learning system.

It is proposed that a multiplicity of universal adversarial perturbations are determined, depending in each case on a specifiable plurality of the training input values. A multiplicity of the respective specifiable plurality of the training input values are perturbed at least using the respective universal adversarial perturbations. The second training of the machine learning system is then additionally performed, depending in each case on the multiplicity of the perturbed specifiable plurality of the training input values.

An advantage of this is that in the second training phase the machine learning system becomes robust against a number of different universal adversarial perturbations, thus enabling the training to be carried out faster. This can also enable a higher generalization of the training input data, since multiple universal adversarial perturbations can be taken into account during the training and at the same time incorporated into the adjustment of the parameters of the machine learning system.

It is also proposed that a maximum size of the universal adversarial perturbation can be specified.

This has the advantage that all data points of the input variable of the machine learning system are equally perturbed and the adversarial perturbation cannot manipulate any one data point more strongly.

It is also proposed that the specifiable plurality of the training input values comprises at least half of the included training input values of a batch which is used in the first training phase.

It has been found that this results in a good trade-off between computational effort and the quality of the adversarial perturbation.

It is also proposed that the trained machine learning system determines an output value based on a detected sensor value. A control variable can be determined dependent on the output value of the trained machine learning system.

The control variable can be used to control an actuator of a technical system. The technical system can be, for example, an at least semi-autonomous machine, an at least semi-autonomous vehicle, a robot, a tool, a machine tool or a flying object such as a drone.

According to a further aspect, a computer program is proposed. The computer program is configured to execute one of the previously mentioned methods. The computer program comprises instructions that cause a computer to execute one of the above methods with all its steps when the computer program is run on the computer. A machine-readable memory module is also proposed, on which the computer program is stored. In addition, an apparatus is proposed which is configured to execute one of these methods mentioned, and a product which is available by execution of one of these methods.

### BRIEF DESCRIPTION OF THE DRAWINGS

Exemplary embodiments are shown in the attached drawings and explained in more detail in the following description. These show:

FIG. 1 a schematic illustration of an at least semi-autonomous vehicle;

FIG. 2 a schematic representation of an embodiment of the method for operating a machine learning system; and

FIG. 3 a schematic drawing of an embodiment of an apparatus which can be used for training the machine learning system.

### DETAILED DESCRIPTION

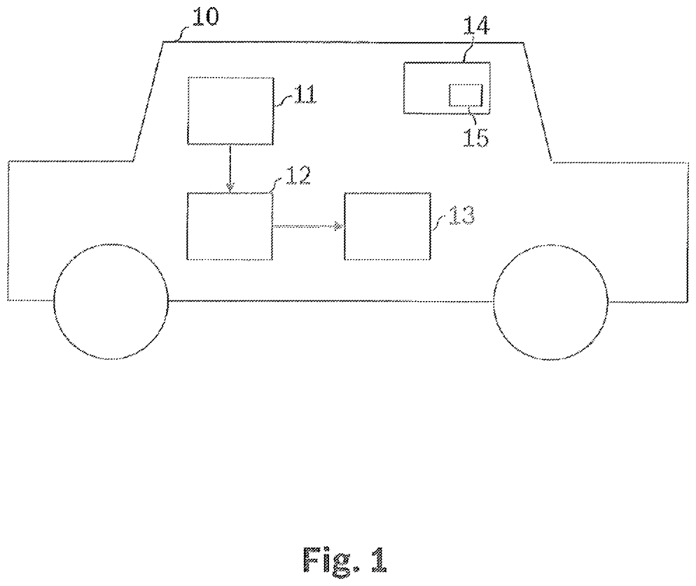

FIG. 1 shows a schematic drawing of an at least semi-autonomous vehicle (10). In a further exemplary embodiment, the at least semi-autonomous vehicle (10) can be a service, assembly, or stationary production robot, alternatively an autonomous flying object, such as a drone. The at least semi-autonomous vehicle (10) can comprise a detection unit (11). The detection unit (11) can be, for example, a camera, which captures an environment of the vehicle (10). The detection unit (11) can be connected to a machine learning system (12). The machine learning system (12) determines an output value depending on a supplied input value, e.g. supplied by the detection unit (11), and depending on a multiplicity of parameters of the machine learning system (12). The output value can be forwarded to an actuator control unit (13). The actuator control unit (13) controls an actuator depending on the output value of the machine learning system (12), and preferably controls the actuator in such a way that the vehicle (10) performs a collision-free maneuver. The actuator in this exemplary embodiment can be a motor or a braking system of the vehicle (10).

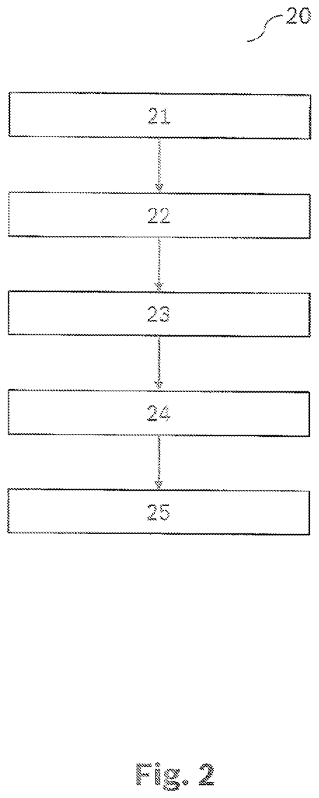

The vehicle (10) also comprises a processing unit (14) and a machine-readable memory element (15). The memory element (15) can be used for storing a computer program which comprises commands, which on execution of the commands on the processing unit (14) cause the processing unit (14) to execute the method for operating the machine learning system (12), e.g. as shown in FIG. 2. It is also conceivable that a download product or an artificially generated signal, either of which can comprise the computer program, after being received on a receiver of the vehicle (10) cause the processing unit (14) to execute this method.

In an alternative exemplary embodiment the machine learning system (12) can be used for a building control system. A user response is detected by means of a sensor, for example a camera or a motion detector, and the actuator control unit controls, for example, a heat pump of a heating system depending on the output value of the machine learning system (12). The machine learning system (12) can then be configured to determine which mode of operation of the building control system is desired based on the acquired user response.

In a further exemplary embodiment the actuator control unit (13) comprises an access enabling system. The access enabling system decides whether or not an object, such as a detected robot or a detected person, has access to an area, depending on the output value of the machine learning system (12). Preferably, the actuator, for example a door opening mechanism, is controlled by means of the actuator control unit (13). The actuator control unit (13) of the previous exemplary embodiment of the building control system can also comprise this access enabling system.

In an alternate exemplary embodiment, the vehicle (10) can be a tool, a machine tool or a manufacturing robot. A material of a workpiece can be classified by means of the machine learning system (12). The actuator can be, for example, a motor which operates a grinding head.

In a further embodiment, the machine learning system (12) is used in a measuring system, which is not shown in the figures. The measuring system differs from the vehicle (10) in accordance with FIG. 1 in that the measuring system does not have an actuator control unit (13). Instead of forwarding the output value of the first machine learning system (12) to the actuator control unit (13), the measuring system can store or display it, for example by means of visual or auditory representations.

It is also conceivable that in a further development of the measuring system the detection unit (11) captures an image of a human or animal body or a part thereof. For example, this can be detected by means of an optical signal, by means of an ultrasonic signal, or by means of an MRI/CT procedure. The measuring system in this development can comprise the first trained neural network (201), which is trained so as to output a classification depending on the input value, for example, which disease may be present on the basis of this particular input value.

The machine learning system (12) can comprise a deep neural network, in particular a convolutional neural network).

FIG. 2 shows a schematic representation of an embodiment of a method (20) for operating a machine learning system.

The method (20) starts at step 21. In step 21, the machine learning system (12) is trained based on the supplied training data, which comprises training/input values and output values. The training of the machine learning system (12) can be carried out as described in the following example. The machine learning system (12) determines an output value based on each of the multiplicity of training input values, in particular images. These output values are then combined with the training output values, which are each associated with one of the multiplicity of training inputs and, in particular, appropriately labeled, to compute a cost function. The cost function is also dependent on a parameterization of the machine learning system (12). After the cost function has been determined, by means of an optimization procedure, in particular a gradient descent procedure, the cost function is optimized, in particular minimized or maximized, depending on the parameterization of the machine learning system (12).

The particular parameterization calculated that was determined by means of the optimization procedure is then an optimal parameterization of the machine learning system (12) in relation to the cost function from step 21, since with this parameterization, as a function of the training input values the machine learning system (12) determines training output values associated with each of these training input values. It should be noted that as a result of outliers in the training data or as a result of a local optimum being found, the machine learning system (12) can only correctly determine a multiplicity of the training output values associated with the training input values.

Preferably, a batch size comprising 128 training input values is selected for the training. The step 21 can be repeated multiple times until a value of the cost function is less than a specifiable value.

After step 21 has been completed, it is followed by step 22. In this step, a universal adversarial perturbation is determined as a function of a specifiable plurality of the training input values. The determination of a universal adversarial perturbation as a function of a plurality of input values of a machine learning system is shown, for example, in the documents cited in the “Prior Art” section. For example, the universal adversarial perturbation can be determined as a function of this specifiable plurality of the training inputs and a gradient of a cost function. Preferably, this cost function is determined depending on output values, which the machine learning system (12) has determined based on the plurality of the training input values, and depending on the respectively associated training output values. Alternatively, the cost function from the previous step 21 can be used to determine the universal adversarial perturbation.

The training input values which are used to determine the universal adversarial perturbation can be selected, for example, at random from the training input values, alternatively, the plurality of the training input values is selected at random from the training input data of one of the batches used for training the machine learning system (12) from step 21. Preferably, the universal adversarial perturbation is determined using 64 training input values.

After the universal control variable has been determined in step 22, this is followed by step 23. In step 23, each of the training input values of the plurality of training input values is perturbed with the universal adversarial perturbation. It should be noted that the training output values that are each associated with the perturbed training input values are not changed.

In the subsequent step 24, the machine learning system (12) is trained using the training input values perturbed with the universal adversarial perturbation. In this case the machine learning system (12) is trained in such a way that the machine learning system (12), in spite of the perturbed training input values, determines training output values associated with each of these training input values. For this purpose a cost function can be optimized with respect to the parameters of the machine learning system (12), which is a function of output values of the machine learning system (12) that were determined based on the perturbed training input values, and a function of the associated training output values.

Alternatively, in step 24 the machine learning system can be trained based on the training input values perturbed with the universal adversarial perturbation value and based on a multiplicity of the training input values supplied from step 21, in particular those which were not used for the determination of the universal adversarial perturbation. The cost function here can be dependent on the determined output values of the machine learning system (12) based on the perturbed and the multiplicity of the supplied training input values. In addition, the cost function can depend on the training output values, which are associated with the perturbed training input values, and the multiplicity of the supplied training input values, and the parameterization of the machine learning system (12).

In a further embodiment of the method (20), the steps 21 through 24 are repeated multiple times in sequence, until a specifiable criterion is satisfied. The specifiable criterion can characterize an influence of the universal adversarial perturbations on the output value of the machine learning system (12). For example, whether the machine learning system (12) uses a training input value perturbed with the universal adversarial perturbation as a basis for determining the training output value associated with this perturbed training input value.

After step 24 has been completed, step 25 can optionally be performed. In step 25, sensor values detected by means of the detection unit (11) are supplied as the input variable of the machine learning system (12). The machine learning system (12) determines an output value depending on its input value. A control variable can then be determined by means of the actuator control unit (13). This control variable can be used for controlling the actuator.

This terminates the procedure. It goes without saying that the method can be implemented not only completely in software as described, but also in hardware, or in a mixed form of software and hardware.

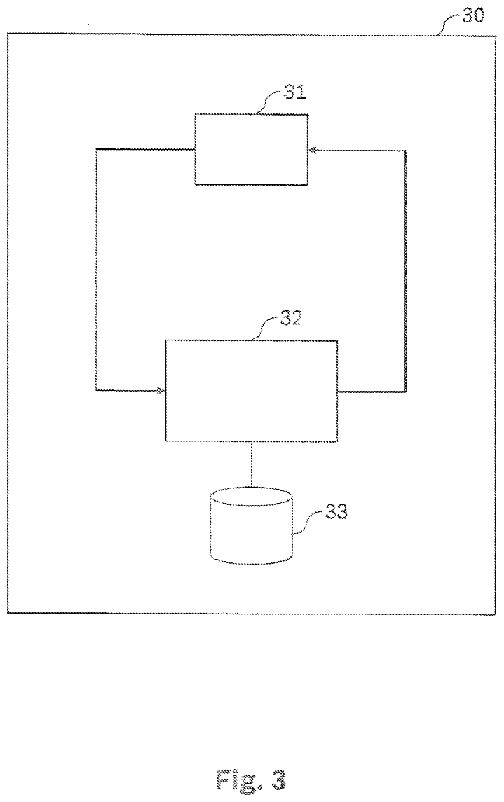

FIG. 3 shows a schematic representation of an apparatus (30) for training the machine learning system (12), in particular for executing step 21 and/or 24 of the method (20). The device (30) comprises a training module (31) and a module (32) to be trained. This training module (32) comprises the machine learning system (12). The apparatus (30) for training the machine learning system (12) trains the machine learning system (12) based on output values of the machine learning system (12) and preferably with the supplied training data. During the training process, parameters of the machine learning system (12), which are stored in a memory (33), are adjusted.

What is claimed is:

1. A method for operating a machine learning system, the method comprising:
in an intial training, training the machine learning system, depending on first training input values and associated first training output values, such that as a function of the first training input values the machine learning system determines a multiplicity of the first training output values assigned respectively to the first training input values;
determining a universal adversarial perturbation as a function of a specified plurality of the first training input values and a cost function of the machine learning system, wherein the machine learning system is deceived using the universal adversarial perturbation such that the machine learning system, depending on each of the specified plurality of the first training input values perturbed in each case with the universal adversarial perturbation, does not determine its assigned first training output values;
perturbing each of the specified plurality of the first training input values with the universal adversarial perturbation; and
in a second training, training the machine learning system, depending on the perturbed specified plurality of the first training input values and a multiplicity of second training input values, such that the machine learning system determines a multiplicity of second training output values as a function of the perturbed specified plurality of the first training input values and the multiplicity of the second training input values.

2. The method according to claim 1 further comprising:
repeating, at least once, the determining the universal adversarial perturbation, the perturbing the specified plurality of the first training input values, and the second training.

3. The method according to claim 1, wherein:
the determining the universal adversarial perturbation further comprises determining a multiplicity of universal adversarial perturbations, in each case depending on a respective specified plurality of the first training input values,
the perturbing the specified plurality of the first training input values further comprises perturbing, using the respective universal adversarial perturbations, a multiplicity of the specified plurality of the first training input values,
the second training further comprises training the machine learning system as a function of the perturbed multiplicity of the specified plurality of the first training input values.

4. The method according to claim 1 further comprising:
specifying a maximum size of the universal adversarial perturbation.

5. The method according to claim 1, wherein the specified plurality of the first training input values comprises at least half of the first training input values of a batch of the initial training.

6. The method according to claim 1 further comprising:
determining, after the second training, an output value as a function of a detected sensor value; and
determing a control variable as a function of the output value.

7. The method according to claim 1, wherein the method is performed by a computer program executed on a computer.

8. The method according to claim 1, wherein the computer program is stored on a non-transitory machine-readable storage element.

9. An apparatus for operating a machine learning system, the apparatus being configured to:
in an intial training, train the machine learning system, depending on first training input values and associated first training output values, such that as a function of the first training input values the machine learning system determines a multiplicity of the first training output values assigned respectively to the first training input values;
determine a universal adversarial perturbation as a function of a specified plurality of the first training input values and a cost function of the machine learning system, wherein the machine learning system is deceived using the universal adversarial perturbation such that the machine learning system, depending on each of the specified plurality of the first training input values perturbed in each case with the universal adversarial perturbation, does not determine its assigned first training output values;
perturb each of the specified plurality of the first training input values with the universal adversarial perturbation; and
in a second training, train the machine learning system, depending on the perturbed specified plurality of the first training input values and a multiplicity of second training input values, such that the machine learning system determines a multiplicity of second training output values as a function of the perturbed specified plurality of the first training input values and the multiplicity of the second training input values.

10. A product comprising:
a machine learning system,
wherein the machine learning system is trained by:
in an intial training, training the machine learning system, depending on first training input values and associated first training output values, such that as a function of the first training input values the machine learning system determines a multiplicity of the first training output values assigned respectively to the first training input values;
determining a universal adversarial perturbation as a function of a specified plurality of the first training input values and a cost function of the machine learning system, wherein the machine learning system is deceived using the universal adversarial perturbation such that the machine learning system, depending on each of the specified plurality of the first training input values perturbed in each case with the universal adversarial perturbation, does not determine its assigned first training output values;
perturbing each of the specified plurality of the first training input values with the universal adversarial perturbation; and
in a second training, training the machine learning system, depending on the perturbed specified plurality of the first training input values and a multiplicity of second training input values, such that the machine learning system determines a multiplicity of second training output values as a function of the perturbed specified plurality of the first training input values and the multiplicity of the second training input values.
